(19) United States
(12) Patent Application Publication
(10) Pub. No.: US 2006/0046795 A1
(43) Pub. Date: Mar. 2, 2006

(54) Cellular phone with separate antenna

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/209,108

(22) Filed: Aug. 22, 2005

(30) Foreign Application Priority Data
Aug. 27, 2004 (TW) 93213611

(51) Int. Cl. H04Q 7/20

(52) U.S. Cl. 455/575.2

(57) ABSTRACT

A cellular phone suite includes a main body (10) and a pair of glasses (20). The glasses have a frame (21). The frame has the function of an antenna for wireless communication. The cellular phone further includes a first transceiver (12) and a second transceiver (22). The first transceiver is mounted on the main body. The second transceiver is mounted on the frame. The first and second transceivers communicate with each other, for establishing the communication between the main body and the frame. Without the extra volume of an antenna, the main body of the cellular phone is convenient to carry.

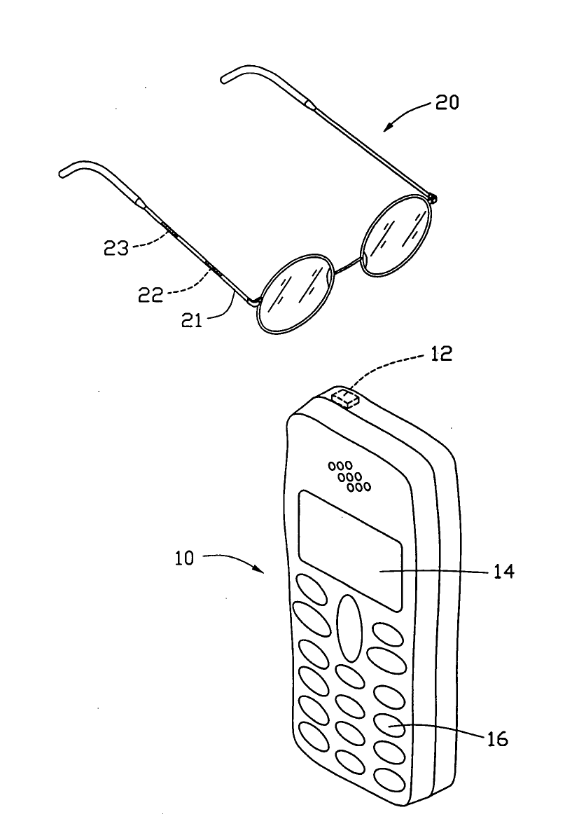

### FIELD OF THE INVENTION

The present invention relates to cellular phones, and particularly to a cellular phone with a separate antenna.

### GENERAL BACKGROUND

As the technology of cellular phones advances, various new functions are being incorporated into them. Cellular phones provide a lot of convenience to people. In general, a cellular phone has a main body and an antenna extending from the main body. The main body of a typical cellular phone is quite compact. However, the antenna necessarily occupies some space in the main body, and limits the extent to which the cellular phone can be miniaturized.

What is needed, therefore, is a cellular phone which is conveniently miniaturized.

### SUMMARY

A cellular phone suite of a preferred embodiment includes a main body and a pair of glasses. The glasses have a frame. The frame has the function of an antenna for wireless communication. The cellular phone further includes a first transceiver and a second transceiver. The first transceiver is mounted on the main body. The second transceiver is mounted on the frame. The first and second transceivers communicate with each other, for establishing communication between the main body and the frame.

Without the extra volume of an antenna, the main body of the cellular phone is small and convenient to carry.

Other advantages and novel features will become more apparent from the following detailed description of preferred embodiments when taken in conjunction with the accompanying drawing, in which:

### BRIEF DESCRIPTION OF THE DRAWING

The drawing is an isometric view of a cellular phone and a pair of glasses according to a preferred embodiment of the present invention, the glasses having a frame serving as a separate antenna of the cellular phone.

### DETAILED DESCRIPTION OF THE EMBODIMENTS

Referring to the drawing, a wireless communication device like a cellular phone and personal belongings like a pair of glasses or spectacles 20 according to a preferred embodiment of the present invention are shown. The cellular phone includes a main body 10. The main body 10 has a display 14 and a keypad 16. The glasses have a frame 21. The frame 21 functions as an antenna for establishing wireless communication between the cellular phone and a base station.

A first transceiver 12 is mounted on a top portion of the main body 10. The first transceiver 12 is electrically connected with a circuit board (not shown) inside the main body 10. A battery (not shown) of the cellular phone supplies electric power for the first transceiver 12. A second transceiver 22 and a battery 23 are mounted on one of the temples of the frame 21. The frame 21, the second transceiver 22 and the battery 23 are electrically connected with each other. The battery 23 supplies electric power for the frame 21 and the second transceiver 22. The first and second transceivers 12 and 22 communicate with each other, for establishing communication between the main body 10 and the frame 21. In this embodiment, wireless signals transmitted between the first and second transceivers 12 and 22 are in a form of infrared waves, and comply with the IrDA (Infrared Data Association) standard.

The frame 21 is generally made of a shape memory alloy comprising material selected from the group consisting of NiTi, TiNiCu, TiNiNb, FeMnAl, CuZrAl, and CuAlNi. Due to being formed of shape memory alloy, the frame 21 has a “shape memory” feature. Accordingly, the frame 21 can fit users having various different head and face sizes and contours. Any individual user can enjoy a comfortable fit. An elastic modulus of the shape memory alloy is in the range from 50 GPa to 150 GPa. Preferably, the elastic modulus is in the range from 80 GPa to 100 GPa. A tensile strength of the shape memory alloy is in the range from 500 MPa to 2000 MPa. The tensile strength is preferably in the range from 800 MPa to 1200 MPa.

In various embodiments, the glasses 20 can be nearsighted glasses, farsighted glasses, or sunglasses.

In summary, without the extra volume of an antenna, the main body 10 of the cellular phone is small and convenient to carry.

It is to be further understood that even though numerous characteristics and advantages of the embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cellular phone suite comprising:
a main body comprising a first transceiver mounted thereon; and
a pair of glasses, comprising
a frame for functioning as an antenna of the cellular phone suite, the frame including a second transceiver mounted thereon, the second transceiver being configured for intercommunicating with the first transceiver.

2. The cellular phone suite as claimed in claim 1, wherein the first and second transceivers comply with the infrared data association standard.

3. The cellular phone suite as claimed in claim 1, wherein the first transceiver is mounted on a top of the main body.

4. The cellular phone suite as claimed in claim 1, wherein the cellular phone further comprises a battery mounted on the frame.

5. The cellular phone suite as claimed in claim 1, wherein the frame comprises a shape memory alloy.

6. The cellular phone suite as claimed in claim 5, wherein the shape memory alloy comprises material selected from the group consisting of NiTi, TiNiCu, TiNiNb, FeMnAl, CuZrAl, and CuAlNi.

7. The cellular phone suite as claimed in claim 5, wherein an elastic modulus of the shape memory alloy is in the range from 50 GPa to 150 GPa.

8. The cellular phone suite as claimed in claim 5, wherein a tensile strength of the shape memory alloy is in the range from 500 MPa to 2000 MPa.

9. An assembly of a wireless communication device comprising:
a main body of said wireless communication device capable of performing functions of said wireless communication device; and
one of personal belongings having electrically conductive pieces extending therein, said one of personal belongings communicable with said main body so as to allow said electrically conductive pieces thereof capable of performing as an antenna of said wireless communication device.

10. The assembly as claimed in claim 9, wherein said one of personal belongings is a wearable pair of spectacles.

11. The assembly as claimed in claim 10, wherein said electrically conductive pieces are formed as a frame of said pair of spectacles.

12. The assembly as claimed in claim 11, wherein said frame is made of shape memory alloy selected from a group consisting of NiTi, TiNiCu, TiNiNb, FeMnAl, CuZrAl, and CuAlNi.

13. The assembly as claimed in claim 9, wherein said one of personal belongings is communicable with said main body via transceivers disposed in said one of personal belongings and said main body respectively and compatible with Infrared Data Association (IrDA) standard.

14. A method to perform wireless communication, comprising the steps of:
transmitting and receiving wireless signals for wireless communication via one of personal belongings having electrically conduective pieces extending therein and capable of being used as an antenna; and
performing communication functions through a main body physically separate from said one of personal belongings after said main body communicates with said one of personal belongings about said wireless signals.

15. The method as claimed in claim 14, wherein said one of personal belongings is a wearable pair of spectacles.
